(19) United States
(12) Patent Application Publication
(10) Pub. No.: US 2021/0307296 A1
(43) Pub. Date: Oct. 7, 2021

(54) Resilient Pet Leash and Adaptive Collar

(71) Applicant: Patty Siu King Lui, Los Angeles, CA (US)

(72) Inventor: Patty Siu King Lui, Los Angeles, CA (US)

(21) Appl. No.: 14/729,448

(22) Filed: Jun. 3, 2015

(51) Int. Cl. A01K 27/00

(52) U.S. Cl. CPC A01K 27/005; A01K 27/004

(57) ABSTRACT

A resilient pet leash, attachable to a collar, includes an elastic inner member and a furrowed cover. When the collar is placed about the animal and the leash attached, the leash can elongate as the inner member stretches. A protective cover for the animal's head and/or neck is attached to the collar.

### FIELD OF THE INVENTION

The invention relates generally to a leash and collar for use on a pet. Specifically, the subject invention discloses a leash comprising an elastic inner member, and a furrowed outer cover, wherein the outer cover entraps the inner elastic member, and is capable of elongating as the inner member is stretched. The present invention further discloses a collar for application about the neck of a pet, wherein the collar comprises an adjustable loop for placement about the neck of a pet, and a protective member attachable to the loop for protecting the head and/or neck portion of the pet. The protective member may further comprise fasteners for shaping the protective member to accommodate various pets.

### BACKGROUND ART

The common pet leash is comprised of a rigid fabric intended to allow for minimal give in controlling a pet when attached to the leash. Typically, the leash is attached to the pet at the collar by a clasp or other attachment means. As the leash is rigid and pets may often accelerate in a random direction, it is very difficult for a pet owner handling the leash to adjust their stance or otherwise prepare for the pets sudden direction change. Especially for larger pets and/or less powerful pet handlers (e.g. children or elderly), the change in direction by a pet attached to the leash may lad to the handler loosing control of the pet and/or injury due to the sudden tug by the pet.

In recent years, the advent of a retractable leash has advanced the art of pet leashes, but there is still plenty to be improved upon and advanced. Exemplary efforts include retractable leashes available with a certain amount of drag so that the lead is automatically retractable once the dog reaches the end of the lead. Elastic leads are also known in the prior art (U.S. Patent Application Publication Number 2005/0229868 to YOUNG, III). Additional methods for addressing the deficiencies have been employed in incorporating elastic leads or leads with elastic sections is described in the following patent specifications: DE 20318612 (MEYER); FR 2765071 (HOUZE); U.S. Pat. No. 5,749,326 (JONES et al): U.S. Pat. No. 6,694,923 (FOUCHE); WO 1997/025859 (JACOBSON); U.S. Pat. No. 4,777,784 (FERGUSON); U.S. Pat. No. 5,915,336 (WATSON).

Furthermore, the present invention discloses a collar fastened to about the neck of a pet, wherein the collar comprises an adjustable loop for placement about the neck of a pet, and a protective member attachable to the loop for protecting the head and/or neck portion of the pet. The protective member may further comprise fasteners for shaping the protective member to accommodate various pets. In addition, the protective member may be oriented to limit the line of sight for the pet, thus reducing the range of vision for the pet and associated visual stimuli for exciting the pet, thus diminishing the incidence of sudden movement by the pet. As the protective member is attached to the loop via fasteners, various sized, shaped, and rigidness of protective members may be incorporated for various situations or to accomplish various outcomes/goals. For instance, in training a pet, it may be advantageous to incorporate a protective member consisting of a mesh material to partially impair the pet's vision, thus training the pet to focus on auditory cues rather than visual ones.

In various aspects of the present invention, the protective member is a wearable fashion item for the pet, including, but not limited to, a hoody, coat, scarf, sweater, jacket, and similar articles of apparel.

However, significant problems still exist in the prior art, including the overall jerking of the pet and/or handler at the end of many of the existing retractable and stationary leash designs, as well as the deficiency of the amount of time provided to a handler and/or pet to adjust for the sudden movement.

Accordingly, it is an object of the present invention to provide a leash and collar implementing a cushion effect with a suitable lead time, to allow for a handler and/or pet to adjust and respond to the sudden movement of a pet, and significantly decrease the likelihood of injury to the pet and/or handler, as well as lose of control of the pet. Furthermore, it an object of this invention to provide augmented control over a pet by incorporating an adaptive protective member for impairing the vision of a pet, thus reducing visual stimuli that may trigger a sudden movement of the pet.

### BRIEF DESCRIPTION OF THE DRAWINGS

These and other features of this invention will be more readily understood from the following detailed description of the various aspects of the invention taken in conjunction with the accompanying drawings in which:

FIG. 1 provides a perspective view of the Resilient Pet Leash and Adaptive Collar in accordance with an embodiment or portion of an embodiment of the present invention.

FIG. 2 depict a perspective view of the Resilient Pet Leash and Adaptive Collar in accordance with an embodiment or portion of an embodiment of the present invention.

FIG. 3 depicts a perspective view of the Resilient Pet Leash and Adaptive Collar in accordance with an embodiment or portion of an embodiment of the present invention.

FIG. 4 provides a perspective view of the Leash element of the Resilient Pet Leash and Adaptive Collar in accordance with an embodiment or portion of an embodiment of the present invention.

FIG. 5 depicts a perspective view of the Leash element of the Resilient Pet Leash and Adaptive Collar in accordance with an embodiment or portion of an embodiment of the present invention.

The attached drawings are merely schematic representations, not intended to portray specific parameters of the invention. Furthermore, the attached drawings are intended to depict only typical embodiments of the invention, and therefore should not be considered as limiting the scope of the invention. In the attached drawings, like numbering represents like elements.

### DETAILED DESCRIPTION OF THE INVENTION

The invention relates generally to a leash and collar for use on a pet. Specifically, the subject invention discloses a leash comprising an elastic inner member, and a furrowed outer member, wherein the outer member conceals the inner elastic member. The elastic inner member is configured to detect a pet handler of any sudden movement by a pet, thus allowing the handler to brace him/herself of the movement. Furthermore, the leash and collar is intended to communicate progressive constraint to be applied to the pet if the pet reaches the length limit of the leash, thus training the pet of the limitation, and substantially reducing the risk of injury to the pet.

The present invention further discloses a collar for application about the neck of a pet. The collar may comprises an adjustable loop for placement about the neck of a pet, wherein adjustment may be accomplished by a belt and buckle device, hook and loop device, or other means known the art. The collar further incorporates a protective member attachable to the loop for protecting the head and/or neck portion of the pet. The protective member may be comprised of textile, plastic, rubber, synthetics, or other materials, and combination of materials. Furthermore, the protective member may be available in different orientations, different shapes, and different sizes to accommodate various pets, as well as to accommodate various functions of the protective member, including, but not limited to: training, protection from the elements or weather, reduction in vision, etc. The protective member may further comprise fasteners for shaping the protective member, thus allowing for additional utility in orienting and shaping the protective member. In further embodiments, the protective member may function, independently or otherwise, as fashion apparel, namely pet clothing, including but not limited to, a hoody, coat, scarf, jacket, sweater, and other apparel items for a pet.

In various embodiments, the leash and collar may be incorporated without the use of the protective element. For instance, when handling the pet during grooming or cleaning. In various embodiments, the collar may be incorporated without the leash, for instance when allowing the pet to roam free in a pet park.

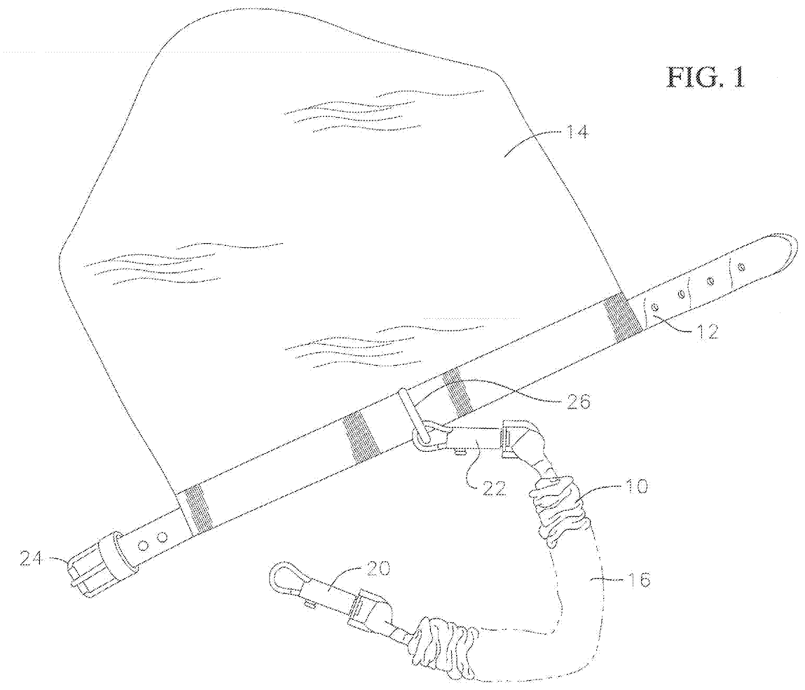

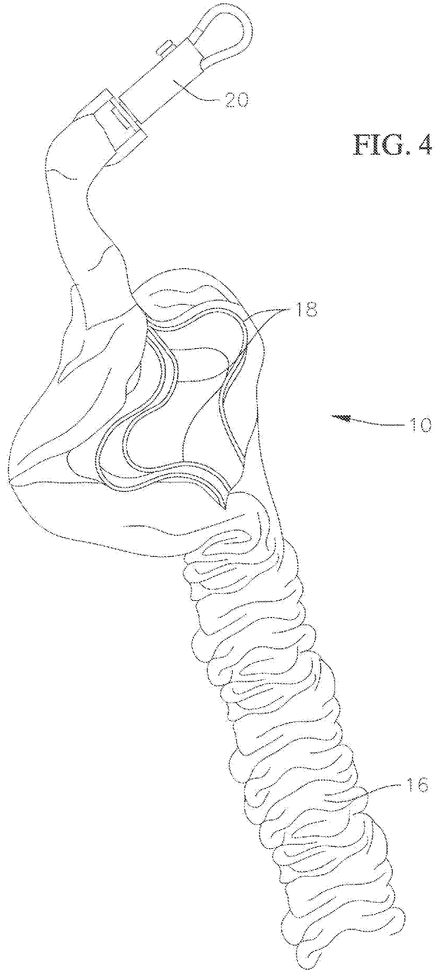

Referring now to the Figures. FIG. 1 provides a perspective view of the Resilient Pet Leash and Adaptive Collar in accordance with an embodiment or portion of an embodiment of the present invention. The pet leash 10 may be constructed of a textile outer cover 16 and a resilient inner member 18 (FIGS. 4 & 5 provide additional details). The pet leash 10 further comprises a first clasp 20 at the distal end of the leash 10, as well as a second clasp 22 at the proximal end of the leash 10. The first clasp 20 and second clasp 22 are permanently attached to either the resilient inner member 18, or the resilient inner member 18 and outer cover 16. The second clasp 22 is configured to attach to a collar 12, and the first clasp 20 is configured to attached to a conventional pet leash (not shown) or handle (not shown). The second clasp 22 attaches to the collar 12 via a closed loop 26, although additional attachment points or elements may be utilized herein.

The collar 12 further comprises a protective element 14 attached to the collar 12. Attachment of the protective element 14 to the collar 12 may be accomplished by various fastening means, including, but not limited to, hook and loop, buttons, snap ties, buckles, clasps, clips, grommets, pins, retaining rings, straps, zipper, variations thereof, and combinations therefrom. The collar 12 is fastened to about the neck of the pet by a removable fastening means 24, depicted in FIG. 1 as a buckle. Various other fastening means have been contemplated in the present invention, and are incorporated herein, including hook and loop, buttons, snap ties, clasps, clips, chains, grommets, pins, retaining rings, straps, tie-down, zipper, variations thereof, and combinations therefrom. The protective element 14 may be configured to fit the upper body and/or head of the pet. Furthermore, the protective element 14 may be configured to mold to the shape of the pet's upper body and/or head. In one embodiment, the protective element 14 further incorporates one or more fasteners to allow for shaping the protective element 14 to the pet. In yet another embodiment, the protective element 14 may be configured with a chin strap designed to encircle the head of the pet, thus securing the protective element 14 to the upper body and/or head of the pet.

Finally, the protective element 14 may be produced using a variety of different materials, including, but not limited to, textiles, including, cotton, wool, silk, flax, jute, hemp, nylon, polyester, acrylic, spandex, synthetic fabrics, acrylonitrile butadiene styrene (ABS), cross-linked polyethylene, low-density polyethylene, linear low-density polyethylene, high-density polyethylene, nylon, polycarbonate, aluminum, acetal, epoxy, ionomer, polyester, polystyrene, silicone, derivatives thereof, and combinations therefrom.

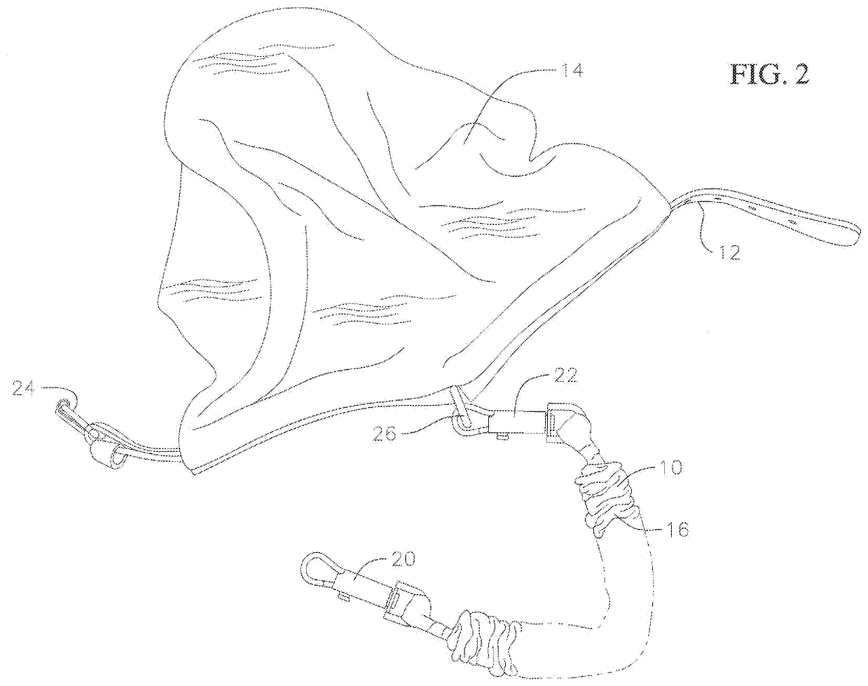

FIG. 2 depict a perspective view of the Resilient Pet Leash and Adaptive Collar in accordance with an embodiment or portion of an embodiment of the present invention. Furthermore, FIG. 2 depict the protective element 14 in a furrowed configuration, which portrays the pliable nature of the protective element 14, rendering it effective to encompass the upper body and/or head of the pet. Furthermore, FIG. 2 depict the pliable nature of the collar 12, allowing for fitment of the collar 12 about the neck of the pet.

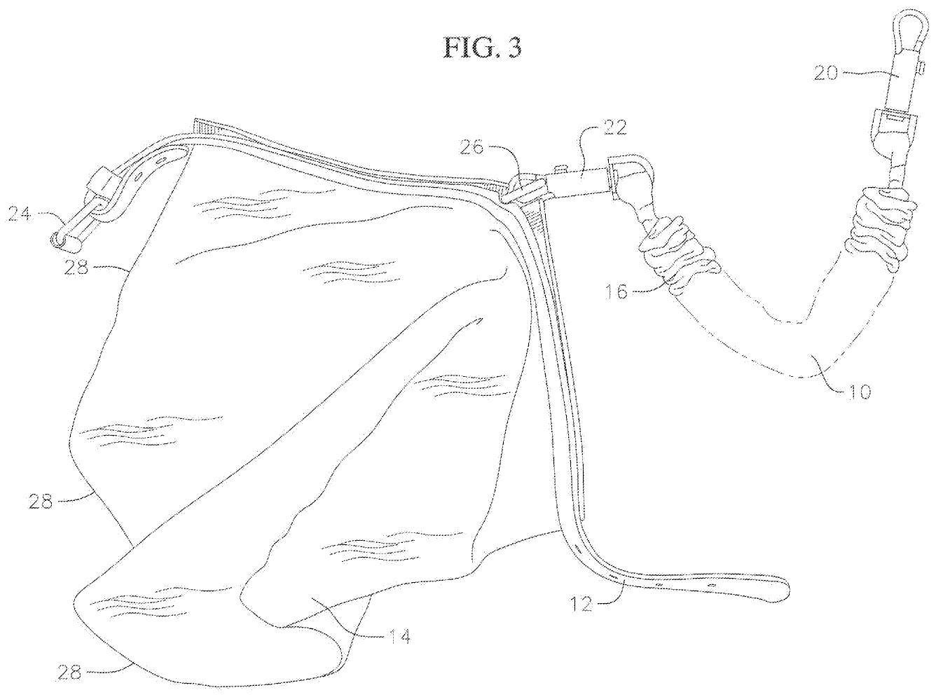

FIG. 3 depicts a perspective view of the Resilient Pet Leash and Adaptive Collar in accordance with an embodiment or portion of an embodiment of the present invention. More specifically, FIG. 3 provides an inverted view of the leash 10, collar 12, and protective element 16. Accordingly, a full view of the collar 12 is provided, wherein the protective element 16 is attached to the opposing side of the collar 12. Furthermore, as provided earlier, the protective element may be configured to mold to the shape of the pet's upper body and/or head, using one or more fasteners 28 to allow for shaping the protective element 14 to the pet's upper body and/or head. The fasteners 28 are portrait in FIG. 3 as hook and loop, however, various other fastening means maybe substituted and/or implemented, including buttons, snap ties, clasps, clips, chains, grommets, pins, retaining rings, straps, tie-down, zipper, variations thereof, and combinations therefrom.

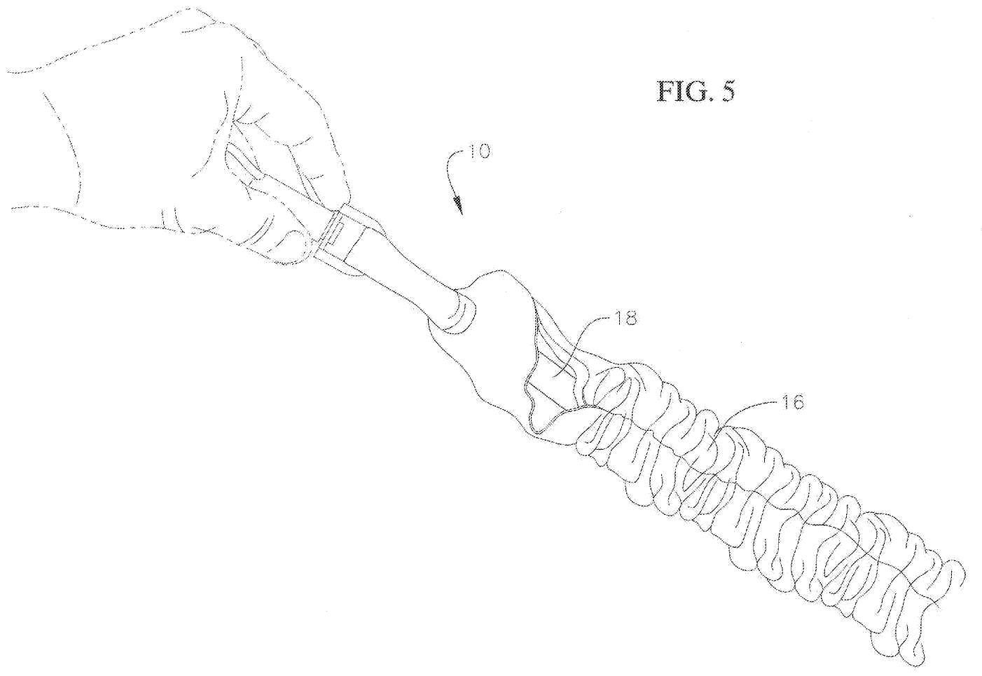

FIGS. 4 and 5 provide perspective views of the Leash element of the Resilient Pet Leash and Adaptive Collar in accordance with an embodiment or portion of an embodiment of the present invention. FIG. 4 depict the leash 10 with a portion of the outer cover 16 partially separated to show the inner resilient member 18. In this particular embodiment, the inner resilient member 18 is comprised of three separate elastic bands, identified as primary band 30, secondary band 32, and tertiary band 34. Although elastic bands have been utilized in this embodiment, any resilient element may be substituted and/or augmented to achieve resiliency in the leash 10. Furthermore, the specific embodiment utilizes three elastic bands, however, any number of resilient element(s) may be contrived in the present invention. Resilient element, as used herein, refers to any and all materials having resilience, defined as the tendency to return to their near original shape before being deformed.

FIG. 4 depict the leash 10 in it's non-stretched, or rest configuration. Here the elastic bands 30, 32, and 34 are in their original, non-deformed, shape. FIG. 5 provides a view of the leash 10 in a stretched configuration, wherein the elastic bands 30, 32, and 34, have been deformed, and are taut. Further depicted in FIG. 5 is the outer cover 16 partially furrowed to compensate for the elongation of the leash 10. In comparison, FIG. 4 and FIG. 5 depict how the outer cover 16 may shrink and expand to compensate for the various configurations of the leash 10 when the resilient member 18 is stretched and returned to it's original shape.

Obviously, numerous additional modifications and variations of the present invention are possible in light of the above teachings. It is therefore to be understood that within the scope of the appended claims, the present invention may be practiced otherwise than as specifically described herein.

1. A leash and collar for a pet comprising:
wherein the leash comprises:
an elastic inner member;
a furrowed outer cover; and
a clasp for attaching the leash,
wherein the collar comprises:
an adjustable loop;
a protective member removably attached to the loop; and
a ring configured on the collar,
wherein the elastic inner member is affixed to the clasp, and the clasp is removably attached to the ring of the collar.

2. The leash and collar of claim 1, wherein the furrowed outer cover encompasses the elastic inner member.

3. The leash and collar of claim 1, wherein the elastic inner member is comprised of one or more resilient element(s).

4. The leash and collar of claim 1, further comprises a second clasp affixed to the leash opposite to the first clasp, such that the second clasp may attach to a conventional leash.

5. The leash and collar of claim 1, wherein the protective member is removably attached to the collar by a fastener.

6. The leash and collar of claim 5, wherein the fastener is selected from a group consisting of: hook and loop, button, snap ties, clasps, clips, chains, grommets, pins, retaining rings, straps, tie-down, zipper, variations thereof, and combinations therefrom.

7. The leash and collar of claim 1, wherein the protective member is constructed, at least in part, from a textile material.

8. The leash and collar of claim 7, wherein textile material is selected from a group consisting of: cotton, wool, silk, flax, jute, hemp, nylon, polyester, acrylic, spandex, synthetic fabrics, acrylonitrile butadiene styrene (ABS), cross-linked polyethylene, low-density polyethylene, linear low-density polyethylene, high-density polyethylene, nylon, polycarbonate, aluminum, acetal, epoxy, ionomer, polyester, polystyrene, silicone, derivatives thereof, and combinations therefrom.

9. A leash for a pet comprising:
an elastic inner member;
a furrowed outer cover; and
a clasp for attaching the leash,
wherein the elastic inner member is affixed to the clasp, and the furrowed outer cover encompasses the elastic inner member.

10. The leash of claim 9 wherein the leash comprises at least two configuration, the first an stretched configuration, wherein the elastic inner member is under tension, and a second rest configuration, wherein the elastic inner member is lax.

11. The leash of claim 9, wherein the elastic inner member is comprised of one or more resilient element(s).

12. The leash of claim 10, wherein the furrowed outer cover at least partially covers the elastic inner member in both the stretched configuration and rest configuration.

13. The leash of claim 9, further comprises a second clasp affixed to the leash opposite to the first clasp, such that the second clasp may attach to a conventional leash.

14. A collar for a pet comprising:
an adjustable loop;
a protective member removably attached to the loop; and
a ring configured on the collar.

15. The collar of claim 14, wherein the protective member is configured to cover at least a portion of the head and/or neck of the pet.

16. The collar of claim 14, wherein the protective member is removably attached to the collar by a fastener.

17. The collar of claim 16, wherein the fastener is selected from a group consisting of: hook and loop, button, snap ties, clasps, clips, chains, grommets, pins, retaining rings, straps, tie-down, zipper, variations thereof, and combinations therefrom.

18. The collar of claim 14, wherein the protective member is constructed, at least in part, from a textile material.

19. The collar of claim 18, wherein textile material is selected from a group consisting of: cotton, wool, silk, flax, jute, hemp, nylon, polyester, acrylic, spandex, synthetic fabrics, acrylonitrile butadiene styrene (ABS), cross-linked polyethylene, low-density polyethylene, linear low-density polyethylene, high-density polyethylene, nylon, polycarbonate, aluminum, acetal, epoxy, ionomer, polyester, polystyrene, silicone, derivatives thereof, and combinations therefrom.

20. The collar of claim 14, wherein the adjustable loop is configured to removably fasten about the neck of the pet by a fastener.

21. The collar of claim 20, wherein the fastener is selected from a group consisting of: hook and loop, button, snap ties, clasps, clips, chains, grommets, pins, retaining rings, straps, tie-down, zipper, variations thereof, and combinations therefrom.

22. The collar of claim 14, further comprising at least one fastener for configuring the protective member to adapt the shape of the pet's head and/or neck.
